(19) United States
(12) Patent Application Publication
(10) Pub. No.: US 2026/0193926 A1
(43) Pub. Date: Jul. 9, 2026

(54) DOOR OPENER WITH IMBALANCE DETECTION CAPABILITY

(71) Applicant: ASSA ABLOY Entrance Systems AB, Landskrona (SE)

(72) Inventors: David P. BRESSON, Pfafftown, NC (US); Davide BRAGGION, Milan (IT); Pasquale DI LORENZO, Milan (IT)

(21) Appl. No.: 19/014,869

(22) Filed: Jan. 9, 2025

(51) Int. Cl. E05F 15/668; E05F 15/40

(52) U.S. Cl. CPC E05F 15/668; E05F 15/40; E05Y 2400/304; E05Y 2400/506; E05Y 2900/106

(57) ABSTRACT

A door operator system may include a sectional door, an opener having a motor operable under control of a controller, a balance module comprising processing circuitry, and a current sensor. The opener may be operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor. The current sensor may be operably coupled to the motor to measure current draw of the motor as current draw data for provision to the balance module to enable the balance module to determine whether the sectional door is in an unbalanced condition based on the current draw data.

### TECHNICAL FIELD

Example embodiments generally relate to movable sectional doors, such as garage doors and, in particular, relate to an opener for such a sectional door that has the ability to detect an unbalanced condition.

### BACKGROUND

Moveable sectional doors, such as garage doors, are commonly used to partition or enclose spaces. Just as commonly, an automated opening device is connected to the sectional doors in order to easily open or close the doors. As an example, a large portion of sectional doors for both residential and industrial applications employ an installed garage door opener (GDO) to automatically open and close the sectional doors. One solution for mounting and operating these GDOs is to mount the GDO from the ceiling proximate to the sectional door. For such ceiling mounted GDOs, a ceiling mounted linear force operator drags one of the connected sections of the sectional door through the guide rails the door rides in as the sectional door transitions between opened and closed positions.

A problem that can be encountered in the context above is that the sectional door may become unbalanced over time. When the sectional door is properly balanced, its weight is evenly distributed and tension management by the springs and other components of the system make the opening effort for the GDO relatively easy. However, when the sectional door becomes unbalanced, extra strain can be placed on the GDO and various other components, which can in some cases lead to component failure. The development of an unbalanced door may happen due to a number of reasons and, in a typical case, the user may get some warning signs before a component failure may occur such as audible or visual clues. However, the sensitivity of users to the warning signs can vary widely, and therefore it would be desirable to provide more automated means of detecting when an unbalanced door problem exists, or even to detect when a door is on its way to becoming unbalanced. Example embodiments may provide means to detect such an imbalance condition, or even to determine when the condition may be in the early stages of developing.

### BRIEF SUMMARY OF SOME EXAMPLES

In an example embodiment, a method of detecting an unbalanced door condition with respect to a sectional door may be provided. The method may include receiving current draw data associated with current draw of a motor of an opener of the sectional door measured while the motor transitions the sectional door between open and closed positions during an opening cycle or a closing cycle, comparing the received current draw data to reference current draw data to determine a difference between the received current draw data and the reference current draw data, and determining the sectional door to be in the unbalanced door condition responsive to the difference being larger than a threshold difference value.

In another example embodiment, a door operator system may be provided. The system may include a sectional door, an opener having a motor operable under control of a controller, a balance module comprising processing circuitry, and a current sensor. The opener may be operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor. The current sensor may be operably coupled to the motor to measure current draw of the motor as current draw data for provision to the balance module to enable the balance module to determine whether the sectional door is in an unbalanced condition based on the current draw data.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a door opener system in a ceiling mounted or trolley configuration in accordance with an example embodiment;

FIG. 2 illustrates a balance module located at the opener of the system in accordance with an example embodiment;

FIG. 3 illustrates a balance module located remotely with respect to the opener of the system in accordance with an example embodiment;

FIG. 4 illustrates a balance module located remotely with respect to the opener and capable of receiving current draw data of the system wirelessly in accordance with an example embodiment;

FIG. 5 illustrates a plot of current draw data to show phases of interest in accordance with an example embodiment;

FIG. 6 illustrates plots of average current draw for opening and closing cycles according to an example embodiment;

FIG. 7 illustrates a detection algorithm for executing a method of identifying an unbalanced door condition according to an example embodiment; and

FIG. 8 illustrates a user interface screen for notifying a user of the unbalanced door condition in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

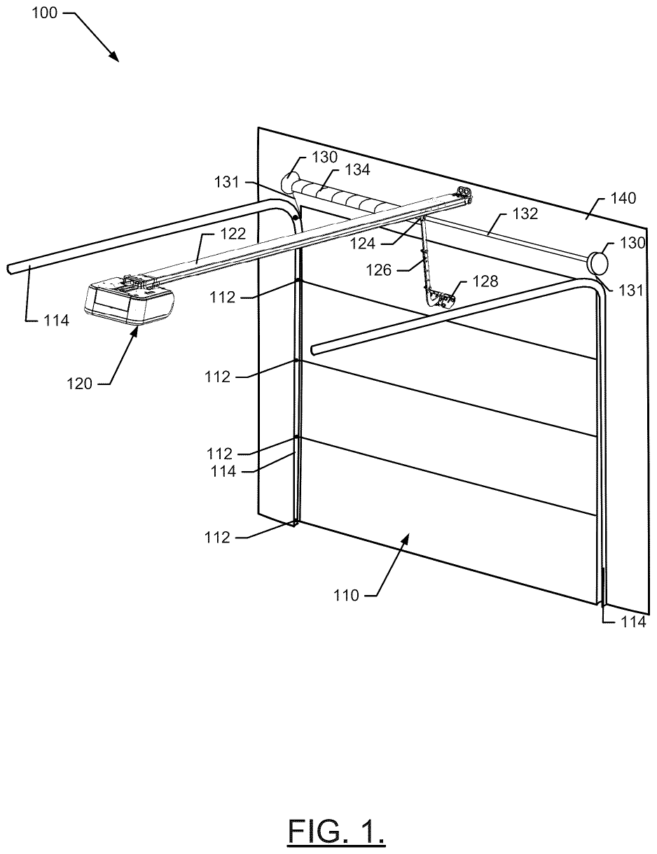

As indicated above, an unbalanced sectional door can be identified via a number of different physical manifestations or noticeable indicia. For example, if the sectional door makes strange or loud noises, or moves unevenly or at a slant when opening or closing, an unbalanced condition may exist. Alternatively, if the sectional door moves unusually slow, or fails to move at all, an unbalanced condition may exist. Whereas the user could certainly wait to notice one of these conditions, the fact of the matter is that once those conditions are noticed, the potential for component damage has already likely been in existence for some time. The motor, spring, rollers, cable, etc., may be damaged and may fail, which may render the door inoperable for a period of time until potentially expensive repairs can be conducted. Accordingly, example embodiments aim to monitor a parameter that can be correlated relatively accurately to an unbalanced door condition, which may indicate the condition prior to, or at least very early on with respect to, any of the noticeable indicia discussed above. In this regard, for example, as any of the physical manifestations or noticeable indicia above may typically occur in conjunction with an increase in the current draw of the motor of the opener. More particularly, the increased friction or otherwise increased work the opener must perform when the sectional door is unbalanced may be expected to necessarily increase the current draw of the motor. Thus, by monitoring current draw over time, it may be possible to detect when the current draw is increasing over time or has reached specific thresholds that suggest that maintenance may be warranted. FIG. 1 illustrate a system in which example embodiments may be employed.

More particularly, FIG. 1 illustrates a garage door operator (GDO) system 100 of an example embodiment. In this regard, FIG. 1 shows the GDO system 100 in a trolley (or ceiling mounted) configuration, but it should be understood that example embodiments may also apply to situations in which the GDO system 100 is in a jackshaft configuration. In both cases, the GDO system 100 includes a sectional door 110, in which each section of the door has rollers 112 operably coupled to opposing lateral sides of the sections. The rollers 112 are typically rotatably operably coupled to the sectional door 110 via brackets that rotatably support a shaft of the rollers 112 and enable a wheel to extend into and ride within rails 114 disposed on opposing sides of the sectional door 110 as the sectional door 110 transitions between open and closed positions. The sectional door 110 of FIG. 1 is shown in the closed position, where the rollers 112 are in a vertical section of the rails 114. Thus, it can be appreciated that in the open position the rollers 112 are located in a horizontally extending portion of the rails 114, and the sectional door 110 is carried into parallel with the ground as opposed to its condition of being perpendicular to the ground in the closed position shown in FIG. 1. Each section of the sectional door 110 can pivot relative to any adjacent section at an intersection thereof in order to enable the sectional door 110 to traverse the bend that separates the horizontally extending portion of the rails 114 from the vertically extending portion of the rails 114.

FIG. 1 also illustrates a GDO unit referred to as an opener 120 or motorhead. The opener 120 of this example is shown in the trolley configuration in which a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a flexible member such as a belt, cable or chain. The belt, cable or chain may also be operably coupled (e.g., via the trolley 124) to a top portion of the sectional door 110 by an engaging arm 126 and engaging bracket 128 that is attached to the sectional door 110. As noted above, the trolley 124 may be manually released from the sectional door 110 to allow for manual repositioning of the sectional door 110.

In some cases, the sectional door 110 may also be supported by one or more instances of cables 131 that are alternately wound onto and off of one or more cable drums 130 disposed at or near opposing ends of a tube 132 (sometimes called a drive tube). The cables 131 may be attached to a bottom portion of the sectional door 110 to assist in carrying the weight of the sectional door 110. The tube 132 may further support a spring assembly 134 that facilitates, along with the cables 131, supporting the weight of the sectional door 110 during opening and closing operations of the sectional door 110 using the opener 120. The sectional door 110, when closed, may block an opening provided in a front wall 140 of the garage in which the GDO system 100 is installed. The opening may be left open when the sectional door 110 is raised onto the horizontally extending portions of the rails 114. As can be seen in FIG. 1, the guide rail 122 may be secured to the front wall 140 at a proximal end of the guide rail 122, and the opener 120 may be suspended from the ceiling of the garage at a distal end of the guide rail 122.

The sectional door 110 is, as noted above, often comprised of panels of aluminum, steel, fiberglass, plastic, or other relatively lightweight, but otherwise structurally rigid material of any suitable type. In some cases, one or more of the panels of the sectional door 110 may include or be comprised of a glass or film that may be transparent or translucent to allow natural light to pass therethrough and into the garage or other space to which the sectional door 110 provides access. The opener 120 draws power, typically from an alternating current (AC) mains power supply, which may be accessed by corded connection to a power supply outlet.

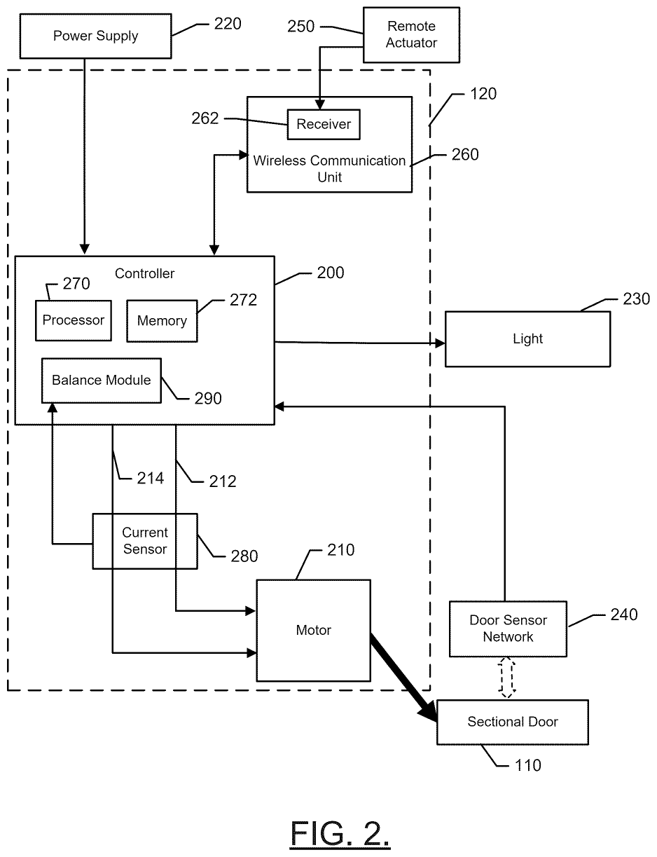

Turning to FIG. 2, a block diagram of various components of a GDO system of an example embodiment is shown. In particular, various internal components of the opener 120 of FIG. 1 are shown. In particular, the opener 120 may include a controller 200 and a motor 210. The motor 210 may operate under control of the controller 200, which may receive power from a power supply 220 (e.g., mains power), and may regulate the provision of power to the motor 210 to control both the operation of the motor 210 and the direction of the operation (e.g., closing or opening). In some cases, the controller 200 may provide separate power for forward (e.g., closing) and reverse (e.g., opening) directions of operation, and such power may be provided as a forward power connection 212 and a reverse power connection 214. The controller 200 may also selectively provide power to a light 230 whenever the motor 210 operates (and for some period thereafter, or when otherwise turned on via the controller 200).

In an example embodiment, a door sensor network 240 may be disposed on or proximate to the sectional door 110 to monitor aspects of the movement of the sectional door 110 and/or its environment. The door sensor network 240 may include motion, speed, force and other sensors associated with movement of the sectional door 110 including, for example, limit switches that determine respective limits for motion of the sectional door 110 in both the opening and closing directions. Moreover, the door sensor network 240 may also include an obstruction sensor, which may detect when an object is between the sectional door 110 and the ground beneath the sectional door 110 to ensure that the sectional door 110 does not close on the object. In some cases, the obstruction sensor may include an infrared or other beam emitter, and a corresponding beam receiver that provides an input to the controller 200 to indicate that the beam emitted by the beam emitter is not being received at the beam receiver (e.g. due to the object, or misalignment of the emitter and receiver). When the controller 200 receives the input from the obstruction sensor, the controller 200 stops provision of power to the motor 210 to stop movement of the motor 210. Similarly, when the limit switches are triggered, the controller 200 is informed and stops movement of the motor 210, which in most cases simply means stopping the provision of power via both the forward and reverse power connections 212 and 214.

In an example embodiment, the controller 200 may be operable responsive to input from a mobile or fixed remote actuator 250 (often simply called a “remote”). In some cases, the remote actuator 250 may be directly or hard wired to the controller 200 and may, for example, be a button, panel or display located on a wall that is convenient for the user to access for operation of the opener 120 inside the garage or other space being enclosed via the sectional door 110. However, particularly for the mobile instances of the remote actuator 250, a wireless communication unit 260 may be included in the opener 120 to receive wireless transmissions from the remote actuator 250 to trigger operation of the controller 200 and consequently also the motor 210. The wireless communication unit 260 may, in some cases, include only a receiver 262 that is capable of receiving transmissions from the remote actuator 250 for triggering operation of the controller 200.

The controller 200 may, in some cases, include processing circuitry that is configured to control the operation of the controller 200. In this regard, for example, the processing circuitry may include a processor 270 and memory 272. The memory 272 may store data, applications (e.g., for execution by the processor 270) or any other suitable information for local or remote usage consistent with the descriptions provided herein. In some cases, the processing circuitry may be part of a printed circuit board (PCB), application specific integrated circuit (ASIC) or other integrated circuit (IC) chip, board or the like. The processing circuitry may therefore, depending on its configuration (e.g., via hardware, firmware and/or software) enable the controller 200 to execute coordinated control over the motor 210 and various other accessories of the GDO system including, potentially, an ability to detect an unbalanced door condition.

In order to incorporate the controller 200 into unbalanced door condition determinations, the controller 200 may be operably coupled to yet another sensor that specifically monitors a parameter that changes when the unbalanced door condition exits. As noted above, current draw by the motor 210 may be one such parameter. Thus, in an example embodiment, the opener 120 may further include a current sensor 280 that may monitor current drawn by the motor 210. In some examples, the current sensor 280 may passively monitor both the forward and reverse power connections 212 and 214 by inductively measuring current in the forward and reverse power connections 212 and 214. However, in other examples, the current sensor 280 may be disposed in series with the forward and reverse power connections 212 and 214 to measure current draw. Any other suitable options for operable coupling of the current sensor 280 to the motor 210 in such a way that permits measurement of current draw thereby is also possible. The current sensor 280 may, in some cases, provide current draw data measured during a door operation cycle (e.g., opening or closing) to the controller 200, and the controller 200 may store the current draw data in the memory 272.

The current measurements made by the current sensor 280 (i.e., the current draw data) may be provided (directly or indirectly) to a balance module 290. The balance module 290 may be configured to monitor the current draw by the motor 210 during operation thereof in order to determine whether an unbalanced condition exists (or may exist). In some embodiments, the balance module 290 may be instantiated as an application stored in the memory 272 and executable by the processor 270. However, in other cases, the balance module 290 may have its own processing circuitry and, as will be discussed in greater detail below, in still other embodiments, the balance module 290 may be located separately from the controller 200. In any case, the current draw data may be processed by the balance module 290 as described herein to determine whether the unbalanced condition exists. In response to determining that the unbalanced condition exists, the opener 120 may provide an alarm or other indication (visual, audible, or electronic message) to the user to indicate as much. Thus, for example, the controller 200 may cause the light 230 to flash with a given pattern that is associated with indicating that the sectional door 110 is unbalanced. However, a display at the controller 200 could alternatively indicate the condition as well.

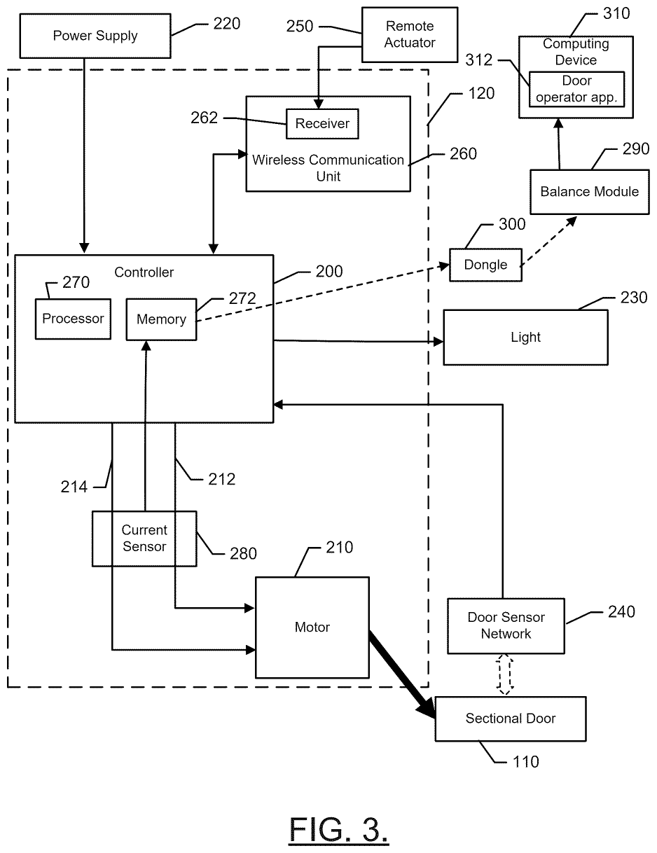

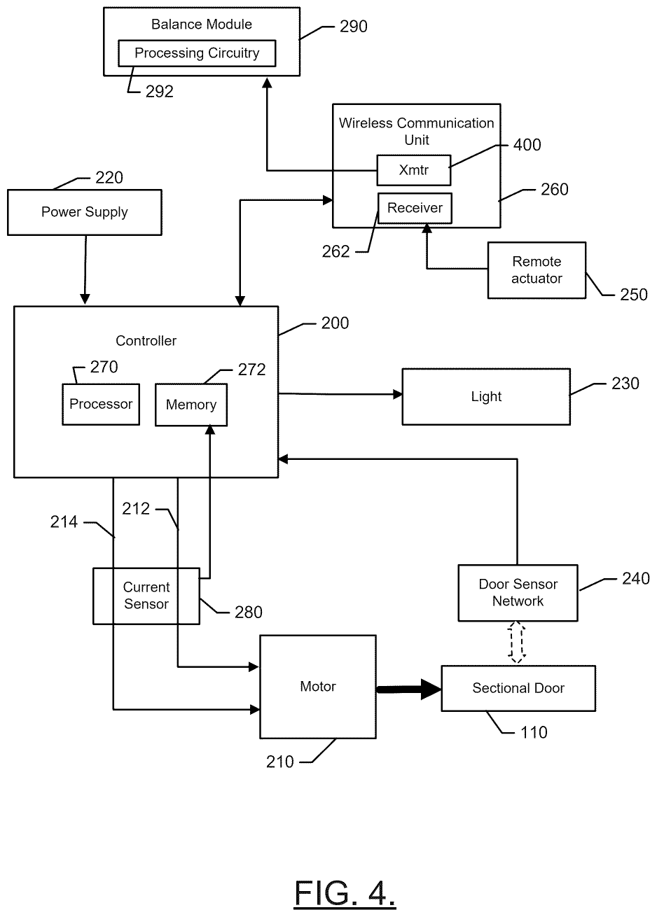

Before discussing how the balance module 290 identifies when the unbalanced condition exists, some alternative structures for implementation of the balance module 290 will be discussed in reference to FIGS. 3 and 4. In this regard, FIG. 3 illustrates an example in which the current draw data is provided from the current sensor 280 directly to the memory 272. A dongle 300, thumb drive or other removable memory may then be used as a transfer device to upload the current draw data from the memory 272 and then download the current draw data to the balance module 290, which may be located remotely from the opener 120. An operator (e.g., maintenance personnel) may install the dongle 300 into the opener 120 to communicate with the memory 272 and then do the same with the balance module 290 at its remote location. In this regard, the balance module 290 may be located at computer of the user, a maintenance entity, or the manufacturer, for example. However, the dongle 300 is just one example tool for transferring data. In other cases, the opener 120 may generate a QR code or other readable code that includes the current draw data, and after receiving the readable code, a reading device may transmit the code or information to the balance module 290. The reader may be operated by a maintenance technician in some cases.

The processing circuitry used to perform the processing of the balance module 290 may therefore include a processor and memory that are located at the respective server or other computing device (including a smart phone or tablet) of the user, maintenance entity or manufacturer. An alert, message or alarm may then be provided at the computing device. However, if the computing device is not the user's, in some cases, the balance module 290 may provide a message to a computing device 310 of the user to indicate the condition. Moreover, a door operator application 320 on the computing device 310 may provide options for interacting with the message including making a service call to maintenance personnel.

FIG. 4 illustrates still another example in which the balance module 290 is remotely located with respect to the controller 200. However, in the example of FIG. 4, the wireless communication unit 260 may further include a transmitter 400 that can transmit the current draw data to the balance module 290. If the balance module 290 is located at the home of the user (e.g., on the user's home computer, tablet or smart phone), the transmitter 400 may use WiFi, Bluetooth©, or other short range wireless communication protocols to send the current draw data to the balance module 290. However, if the balance module 290 is located at a maintenance facility more remote, 5G or other long range wireless communication protocols may be used. The balance module 290 may then provide messages or alerts as discussed above in reference to FIG. 3 when the unbalanced condition is detected via operation of its processing circuitry 292 based on execution of a detection algorithm discussed in greater detail below.

As to determining the unbalanced condition itself, as noted above, the balance module 290 may process the current draw data. The processing may include comparing received current draw data (i.e., the current draw data most recently provided to the balance module 290) to reference current draw data. The reference current draw data may be provided for a class of openers 120 initially, or may be built up over time by, for example, averaging the current draw data previously received to define a running and continuously or periodically updated average of reference current draw data. Regardless of how measured or determined, if the reference current draw data is different from the received current draw data by greater than a threshold amount, then an unbalanced condition may be detected. As noted above, the unbalanced condition may be detected responsive to execution of a detection algorithm by the processing circuitry 292 of the balance module 290. The detection algorithm may be executed to compare the received and reference current draw data and determine a difference therebetween.

Although the general concept of this comparison may be relatively straightforward, it should be appreciated that given the number of cycles of opening and closing that may occur in a given period of time, the amount of data that may ultimately be generated may become cumbersome to process, communicate and/or store. Moreover, it may also be the case that it is not necessary to run comparisons over the full scope of measured data, but instead comparisons may be strategically limited to particular portions of the measured data that are most likely to be informative in relation to the condition being detected. Accordingly, data may in some cases only be processed for particular phases or even event stages within the particular phases. The focus on a smaller section of data may further mean that in some cases, less data needs to be recorded and stored, communicated and processed.

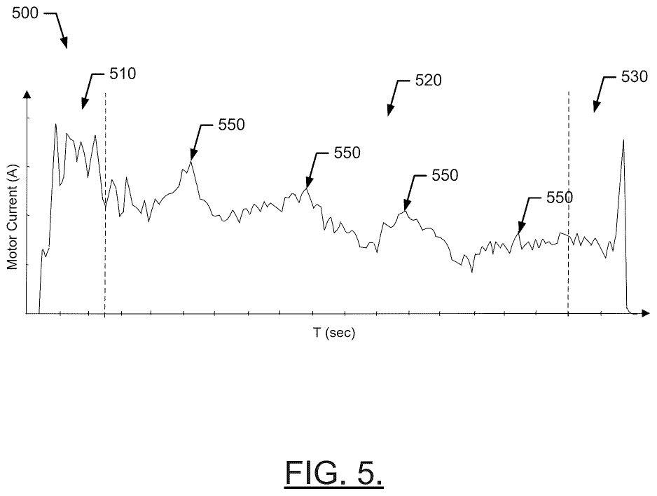

FIG. 5 illustrates an example plot 500 of received current draw data according to an example embodiment. The plot 500 shows current draw versus time for an opening cycle of the sectional door 110. The plot 500 is broken into three phases including a kickoff phase 510, a running phase 520 and a slowdown phase 530. For the opening cycle, the kickoff phase 510 typically involves a large current draw since the full weight of the sectional door 110 is being lifted off the floor. Since the movement of the sectional door 110 in the kickoff phase 510 is largely happening in a vertical section of the rails 114, there may not be much change in the current draw from one cycle to the next, even if measured over a long period of time. Thus, the kickoff phase 510 may not be a good phase to use for detecting imbalance. Likewise, in the slowdown phase 530 of the opening cycle, the sectional door 110 is mostly lying in a horizontal plane getting closer to the opener 120 and slowing down as the limit of motion is approached. Thus, the weight of the sectional door 110 is almost all being borne by the horizontal sections of the rails 114 with little change either in one cycle or across different cycles.

However, during the running phase 520, each section of the sectional door 110 takes its turn transitioning through the portion of the rails 114 that bends from the vertical section thereof to the horizontal section thereof. These transitions occur when the hinges between sections change between the horizontal to the vertical sections, and there tends to be a small surge in current draw to complete the transition event. Each of these transition events (i.e., four of them for a four panel door) is its own even stage that could be considered to be a stage of interest 550, and current tends to reach a noticeable peak during the stages of interest 550. Accordingly, for the purposes of maximizing accuracy with the storage, communication and processing of as little data as possible, in some cases, the balance module 290 may perform the detection algorithm on only data corresponding to the running phase 520, and may further focus on one or more of the event stages associated with each panel transitioning from horizontal to vertical sections of the rails 114. Thus, for example, only peak values may be stored, compared, or otherwise used for the detection algorithm in some cases. Normal ranges of peak values for opening and closing cycles, and sometimes specifically for each hinge set and panel transition, may therefore be stored to determine when performance falls outside normal ranges.

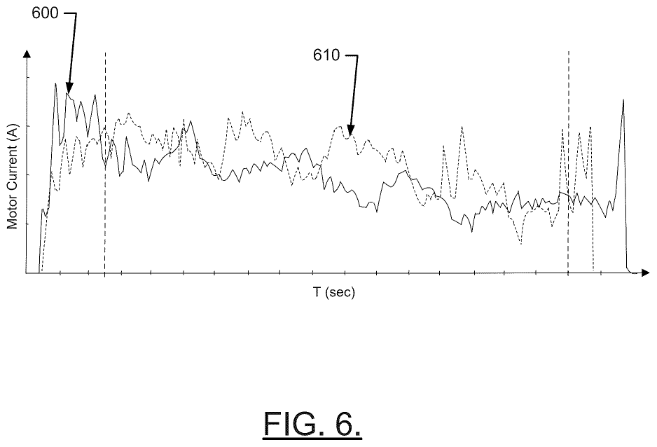

Other strategies for reducing storage requirements or simplifying calculations may include averaging values at intervals. In this regard, for example, the memory 272 may have limited storage capacity. Thus, rather than storing data associated with each and every opening or closing cycle, the memory 272 may average all or some of the data received over a given period of time to store only the average values. FIG. 6 illustrates an average opening cycle plot 600 and an average closing cycle plot 610 to illustrate the averaging concept. Comparisons may be made with respect to the average values of reference and/or received current draw data. Alternatively or additionally, the memory 272 may be selective in its storage strategy. In this regard, for example, the memory 272 may store every third cycle, or any other suitable interval among the cycles. Opening and closing cycles may also be distinguished from each other, and compared to reference data that is specific to the same type of cycle.

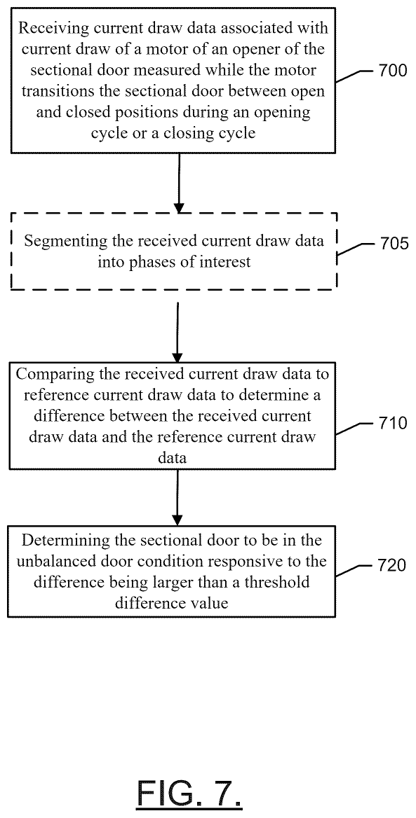

FIG. 7 is a block diagram of a detection algorithm according to an example embodiment. In this regard, the detection algorithm may include receiving current draw data associated with current draw of a motor of an opener of the sectional door measured while the motor transitions the sectional door between open and closed positions during an opening cycle or a closing cycle at operation 700, comparing the received current draw data to reference current draw data to determine a difference between the received current draw data and the reference current draw data at operation 710, and determining the sectional door to be in the unbalanced door condition responsive to the difference being larger than a threshold difference value at operation 720. In some cases, the detection algorithm may further include segmenting the received current draw data into phases of interest at operation 705 as an optional operation. In such cases, comparing the received current draw data to the reference current draw data may only be performed with respect to one of the phases of interest.

The operations above may be modified in some cases. For example, the reference current draw data may include average current draw data averaged over a plurality of opening or closing cycles preceding receipt of the received current draw data. In some cases, in response to the difference being less than the threshold difference value, the received current draw data may be included in averaging with the reference current draw data to generate an updated reference current draw data. In an example embodiment, receiving current draw data may include receiving a batch of current draw data and averaging the batch of current draw data to determine the difference between the averaged batch of the current draw data and the reference current draw data. In some cases, wherein the one of the phases of interest may be further segmented into a plurality of stages of interest, and comparing the received current draw data to the reference current draw data may include comparing a peak current draw at each of the stages of interest to a corresponding peak current draw of the reference current draw data to determine the difference. In an example embodiment, the received current draw data may be segmented into opening received current draw data measured during the opening cycle and closing received current draw data measured during the closing cycle. The reference current draw data may be segmented into opening reference current draw data measured during prior instances of the opening cycle and closing reference current draw data measured during prior instances of the closing cycle. In such a case, comparing the received current draw data to reference current draw data may include comparing the opening received current draw to the opening reference current draw to determine a portion of the difference attributable to the opening cycle and comparing the closing received current draw to the closing reference current draw to determine a portion of the difference attributable to the closing cycle. In some cases, determining the sectional door to be in the unbalanced door condition may include determining the portion of the difference attributable to the opening cycle or the portion of the difference attributable to the closing cycle being larger than the threshold difference value.

In some cases specific conditions may be further diagnosed based on comparing the shape of the curvature of the received current draw data, the magnitude of the peaks, or other aspects of the data to sample defect patterns that may be included in the reference current draw data. For example, the sample defect patterns may include cases for excessive spring wear, over-sprung conditions, hinge faults, rollers that need lubrication, and other conditions. Thus, for example, if the threshold difference value is exceeded, the balance module 290 of some examples may further engage in analysis to attempt to determine the nature of the fault that exists. Moreover, the balance module 290 of some embodiments may include libraries of historical data to enable spring wear calculations and modeling to be performed so that, for example, estimates of time remaining before spring replacement is likely to be needed can be made. In this regard, the balance module may engage in predictive modeling that enables percentage wear estimates to be made for various components of the sectional door 110 or the opener 120. Thus, instead of merely estimating life remaining for components based on number of cycles, the actual performance characteristics of the motor 210 may be studied to make determinations that are specific to the system in operation.

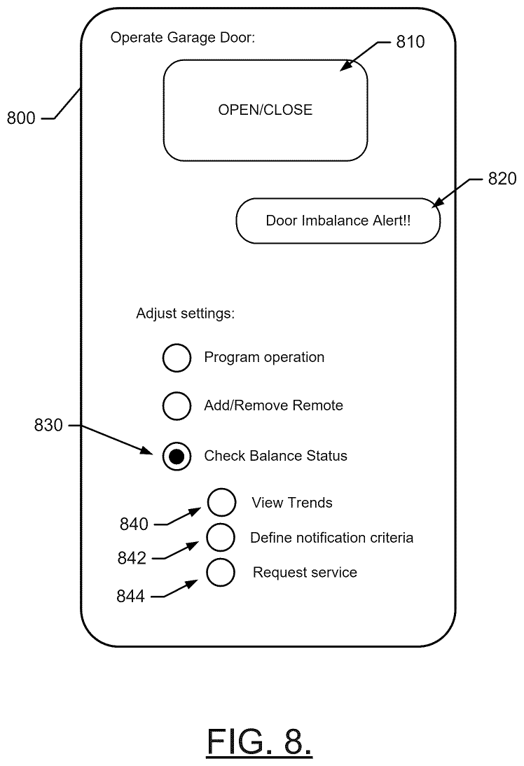

As noted above, when the unbalanced condition is determined, various means of notifying the user may be employed. One such means may be to provide a notification to the user on a smart phone application via which various aspects of the operation of the opener 120 or the system in general may be managed. FIG. 8 illustrates one example of an interface screen 800 that may be used as part of a control console or web page for a remote computer/application. Of note, although the interface screen 800 of FIG. 8 shows an open/close button 810 on the same screen or page as a notification 820 and various other options for adjusting settings for the system, these separate functions may alternatively be provided on separate pages or screens.

In response to receipt of the notification 820, the user may check system settings, which may include an option to check balance status 830 (among other control options). When the check balance status 830 option is selected, various other options may be presented including, for example, the option to review trends 840, define notification criteria 842 or request a service call 844. The service call request, or perhaps another separate option may, in some cases, cause the data to be provided to the service technician or maintenance facility. The user may also or alternatively have a setting that provides a continuous reporting of current draw data to the service technician or maintenance facility and such data may be stored locally for analysis and building of the predictive models noted above. Other options and interactions may also be possible in other example embodiments.

Accordingly, some example embodiments may provide a door operator system that can automatically detect an unbalanced door condition via active or passively measured parameters using a balance module located either locally or remotely. The system may include a sectional door, an opener having a motor operable under control of a controller, the balance module (which may include processing circuitry), and a current sensor. The opener may be operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor. The current sensor may be operably coupled to the motor to measure current draw of the motor as current draw data for provision to the balance module to enable the balance module to determine whether the sectional door is in an unbalanced condition based on the current draw data.

The balance module and/or a system including the same, or components thereof described above may be augmented or modified by altering individual features mentioned above or adding optional features. In this regard, for example, the balance module may be configured to perform the detection algorithm of FIG. 7 above, along with any or all of the modifications discussed above. Moreover, in some cases, the balance module may be located at the opener and generate a notification at the opener in response to the difference being larger than the threshold difference value. In some cases, the balance module may be located remotely from the opener and may generate a notification to a user of the system at a computer, smart phone or tablet of the user in response to the difference being larger than the threshold difference value. In an example embodiment, the balance module may receive the current draw data from the opener via wireless communication.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A method of detecting an unbalanced door condition with respect to a sectional door, the method comprising:
receiving current draw data associated with current draw of a motor of an opener of the sectional door measured while the motor transitions the sectional door between open and closed positions during an opening cycle or a closing cycle;
comparing the received current draw data to reference current draw data to determine a difference between the received current draw data and the reference current draw data; and
determining the sectional door to be in the unbalanced door condition responsive to the difference being larger than a threshold difference value.

2. The method of claim 1, wherein the reference current draw data comprises average current draw data averaged over a plurality of opening or closing cycles preceding receipt of the received current draw data.

3. The method of claim 2, wherein, in response to the difference being less than the threshold difference value, the received current draw data is included in averaging with the reference current draw data to generate an updated reference current draw data.

4. The method of claim 1, wherein receiving current draw data comprises receiving a batch of current draw data and averaging the batch of current draw data to determine the difference between the averaged batch of the current draw data and the reference current draw data.

5. The method of claim 1, further comprising segmenting the received current draw data into phases of interest, and
wherein comparing the received current draw data to the reference current draw data is only performed with respect to one of the phases of interest.

6. The method of claim 5, wherein the one of the phases of interest is further segmented into a plurality of stages of interest, and
wherein comparing the received current draw data to the reference current draw data comprises comparing a peak current draw at each of the stages of interest to a corresponding peak current draw of the reference current draw data to determine the difference.

7. The method of claim 1, wherein the received current draw data is segmented into opening received current draw data measured during the opening cycle and closing received current draw data measured during the closing cycle,
wherein the reference current draw data is segmented into opening reference current draw data measured during prior instances of the opening cycle and closing reference current draw data measured during prior instances of the closing cycle, and
wherein comparing the received current draw data to reference current draw data comprises comparing the opening received current draw to the opening reference current draw to determine a portion of the difference attributable to the opening cycle and comparing the closing received current draw to the closing reference current draw to determine a portion of the difference attributable to the closing cycle.

8. The method of claim 7, wherein determining the sectional door to be in the unbalanced door condition comprises determining the portion of the difference attributable to the opening cycle or the portion of the difference attributable to the closing cycle being larger than the threshold difference value.

9. A door operator system comprising:
a sectional door;
an opener having a motor operable under control of a controller, the opener being operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor;
a balance module comprising processing circuitry; and
a current sensor operably coupled to the motor to measure current draw of the motor as current draw data for provision to the balance module to enable the balance module to determine whether the sectional door is in an unbalanced condition based on the current draw data.

10. The system of claim 9, wherein the balance module determines whether the sectional door is in the unbalanced condition by:
receiving the current draw data associated with current draw of the motor measured while the motor transitions the sectional door between open and closed positions during an opening cycle or a closing cycle;
comparing the received current draw data to reference current draw data to determine a difference between the received current draw data and the reference current draw data; and
determining the sectional door to be in the unbalanced door condition responsive to the difference being larger than a threshold difference value.

11. The system of claim 10, wherein the reference current draw data comprises average current draw data averaged over a plurality of opening or closing cycles preceding receipt of the received current draw data.

12. The system of claim 11, wherein, in response to the difference being less than the threshold difference value, the received current draw data is included in averaging with the reference current draw data to generate an updated reference current draw data.

13. The system of claim 10, wherein receiving current draw data comprises receiving a batch of current draw data and averaging the batch of current draw data to determine the difference between the averaged batch of the current draw data and the reference current draw data.

14. The system of claim 10, further comprising segmenting the received current draw data into phases of interest, and
wherein comparing the received current draw data to the reference current draw data is only performed with respect to one of the phases of interest.

15. The system of claim 14, wherein the one of the phases of interest is further segmented into a plurality of stages of interest, and
wherein comparing the received current draw data to the reference current draw data comprises comparing a peak current draw at each of the stages of interest to a corresponding peak current draw of the reference current draw data to determine the difference.

16. The system of claim 10, wherein the received current draw data is segmented into opening received current draw data measured during the opening cycle and closing received current draw data measured during the closing cycle,
wherein the reference current draw data is segmented into opening reference current draw data measured during prior instances of the opening cycle and closing reference current draw data measured during prior instances of the closing cycle, and
wherein comparing the received current draw data to reference current draw data comprises comparing the opening received current draw to the opening reference current draw to determine a portion of the difference attributable to the opening cycle and comparing the closing received current draw to the closing reference current draw to determine a portion of the difference attributable to the closing cycle.

17. The system of claim 16, wherein determining the sectional door to be in the unbalanced door condition comprises determining the portion of the difference attributable to the opening cycle or the portion of the difference attributable to the closing cycle being larger than the threshold difference value.

18. The system of claim 10, wherein the balance module is located at the opener and generates a notification at the opener in response to the difference being larger than the threshold difference value.

19. The system of claim 10, wherein the balance module is located remotely from the opener and generates a notification to a user of the system at a computer, smart phone or tablet of the user in response to the difference being larger than the threshold difference value.

20. The system of claim 19, wherein the balance module receives the current draw data from the opener via wireless communication.
